(19) United States
(12) Patent Application Publication
(10) Pub. No.: US 2021/0304233 A1
(43) Pub. Date: Sep. 30, 2021

(54) METHOD AND SYSTEM FOR REAL-TIME PREDICTION OF ONE OR MORE ASPECTS ASSOCIATED WITH FASHION RETAILER

(71) Applicant: NextSCM Solutions Pvt. Ltd., Bengaluru (IN)

(72) Inventors: Romil JAIN, Bengaluru (IN); Asish PALLAPOTHU, Visakhapatnam (IN); Anisha SOGANI, Indore (IN); Richa GUPTA, Jaipur (IN); Gaurang Nandkishor JUNGARE, Amravati (IN); Aditya SAMADHIYA, Bengaluru (IN)

(73) Assignee: NextSCM Solutions Pvt. Ltd., Bengaluru (IN)

(21) Appl. No.: 17/064,018

(22) Filed: Oct. 6, 2020

(30) Foreign Application Priority Data
Mar. 31, 2020 (IN) 202041014404

(51) Int. Cl. G06Q 30/02; G06N 5/04; G06Q 10/08; G06Q 10/06

(52) U.S. Cl. CPC G06Q 30/0204; G06Q 10/06375; G06Q 10/087; G06N 5/04

(57) ABSTRACT

The present disclosure provides a method and system for real-time prediction of one or more aspects associated with a fashion retailer for productive sales. The method and system corresponds to an intelligent merchandising system. The intelligent merchandising system receives a plurality of data associated with a plurality of stores of each of one or more fashion retailers. The intelligent merchandising system bins a liquidation sales data from the plurality of data. The intelligent merchandising system clusters a plurality of products into one or more clusters at one or more levels. The intelligent merchandising system smooths the plurality of data for the one or more clusters at each of the one or more levels based on moving averages analysis. The intelligent merchandising system predicts the one or more aspects associated with the plurality of products and the plurality of stores.

### TECHNICAL FIELD

The present invention relates to the field of fashion industry and, in particular, relates to a method and system for real-time prediction of one or more aspects associated with a fashion retailer for productive sales.

### INTRODUCTION

Over the past few years, fashion industry is growing evidently due to increasing fashion consciousness across consumers. Growth of the fashion industry has increased the importance of inventory management. The inventory management is crucial for fashion retailer. The fashion retailer has to meet dynamic demand of the consumers in the fashion industry for stock allocation using the inventory management. In addition, the fashion retailer wants to accelerate store rotation, avoid missed opportunity, and increase sales. Conventionally, the fashion retailer allocates stocks for stores centrally without considering granular aspects of products. In addition, the granular aspects of the products include demand, set size ratio, popular style, seasonal fabrics, trending designs and the like. Further, the fashion retailer is seeking effective ways to allocate the stocks. Furthermore, the fashion retailer is seeking effective ways to buy inventory before the season starts. Moreover, the fashion retailer is seeking effective ways to update the merchandise plan during the season. However, the present systems and methods for predicting optimal categories of the products are inefficient. In addition, the present systems and methods predict eminent styles of the products but not at granular level. Further, the present systems and methods to predict optimal quantity of the products are ineffective. Furthermore, the present systems and methods to predict optimal size set ratio are imprecise.

### SUMMARY

In first example, a computer-implemented method is provided. The computer-implemented method for creating real-time prediction of one or more aspects associated with a fashion retailer for productive sales. The computer-implemented method includes a first step of receiving a plurality of data associated with a plurality of stores of each of one or more fashion retailers, at an intelligent merchandising system with a processor. The computer-implemented method includes a second step of binning a liquidation sales data from the plurality of data at the intelligent merchandising system with the processor. The computer-implemented method incudes a third step of clustering a plurality of products into one or more clusters at one or more levels. The computer-implemented method incudes a fourth step of smoothing the plurality of data for each of the one or more clusters at each of the one or more levels based on moving averages analysis at the intelligent merchandising system with the processor. The computer-implemented method incudes a fifth step of predicting the one or more aspects associated with each of the plurality of products and the plurality of stores of each of the one or more fashion retailers at the intelligent merchandising system with the processor. The binning is done for eliminating the liquidation sales data from the plurality of data based on a revenue loss threshold on the plurality of products. IN addition, the clustering is done based on one or more attributes of the plurality of products and the plurality of stores of each of the one or more fashion retailers. The clustering is done in real-time. The smoothing is done for enabling prediction of the one or more aspects at the one or more levels. Further, the smoothing of the plurality of data is done in real-time. The prediction is done for achieving a user defined revenue target in a pre-defined period of time for a plurality of results. The user defined revenue target is defined by the one or more fashion retailers. Furthermore, the plurality of results comprising determination of a popularity index, optimization of quantity, and maximizing revenue, wherein the one or more aspects are predicted in real-time.

In an embodiment of the present disclosure, the plurality of data comprising past sales data, seasonality data, product attributes data, store inventory data, and warehouse inventory data.

In an embodiment of the present disclosure, the one or more levels comprising style, organization, cluster, size, and store.

In an embodiment of the present disclosure, the one or more attributes comprising merchandise category, price-range, size ratio, fabric, color, design, brand and fit.

In an embodiment of the present disclosure, the one or more aspects includes a set of merchandise categories of the plurality of products for the pre-defined period of time, a first set of products from the plurality of products, a set of quantities of the plurality of products for the pre-defined period of time, a set of options of the plurality of products, a set of size set ratio of the plurality of products, optimal allocation of the plurality of products, a second set of products from the plurality of products, and a set of selling price of the plurality of products.

In an embodiment of the present disclosure, the liquidation sales data corresponds to sales data of a third set of products from the plurality of products. The liquidation sales data contributes up to a pre-defined revenue. The pre-defined revenue is defined by the one or more fashion retailers.

In an embodiment of the present disclosure, the smoothing is done for controlling a set of distributions and a set of sales of the plurality of products at the one or more levels. The set of distributions comprising out of stock, over stock, and poor procurement. The set of sales is based on the one or more attributes of the plurality of products. The smoothing ensures that variation in the plurality of data are aligned using the moving averages analysis.

In an embodiment of the present disclosure, the computer-implemented method includes evaluation of the popularity index of each of the plurality of products based on analysis of the plurality of data at the one or more levels for the pre-defined period of time. The popularity index is based on a plurality of parameters of each of the plurality of products. The plurality of parameters includes revenue and discount. The popularity index enables prediction of the first set of products from the plurality of products. The popularity index is evaluated in real-time.

In an embodiment of the present disclosure, the computer-implemented method includes binning products from the plurality of products based on the popularity index above a threshold value for the pre-defined period of time at the intelligent merchandising system. The threshold value is defined by the one or more fashion retailers. The products correspond to the first set of products from the plurality of products. The binning is done in real-time.

In second example, a computer system is provided. The computer system includes one or more processors, a signal generator circuitry embedded inside a computing device for generating a signal, and a memory. The memory is coupled to the one or more processors. The memory stores instructions. The instructions are executed by the one or more processors. The execution of instructions causes the one or more processors to perform a method for real-time prediction of one or more aspects associated with a fashion retailer for productive sales. The method includes a first step to receive a plurality of data associated with a plurality of stores of each of one or more fashion retailers at an intelligent merchandising system. In addition, the method includes a second step to bin a liquidation sales data from the plurality of data at the intelligent merchandising system. The binning is done to eliminate the liquidation sales data from the plurality of data based on a revenue loss threshold on a plurality of products. Further, the method includes a third step to cluster the plurality of products into one or more clusters at one or more levels at the intelligent merchandising system. The clustering is done based on one or more attributes of the plurality of products and the plurality of stores of each of the one or more fashion retailers. The clustering is done in real-time. Furthermore, the method includes a fourth step to smooth the plurality of data for each of the one or more clusters at each of the one or more levels based on moving averages analysis. The smoothing is done to enable prediction of the one or more aspects at the one or more levels. The smoothing of the plurality of data is done in real-time. Moreover, the method includes a fifth step to predict the one or more aspects associated with each of the plurality of products and the plurality of stores of each of the one or more fashion retailers. The prediction is done to achieve a user defined revenue target in a pre-defined period of time for a plurality of results. The plurality of results includes determination of a popularity index, optimization of quantity, and maximizing revenue. The one or more aspects are predicted in real-time.

In third example, a non-transitory computer-readable storage medium is provided. The non-transitory computer-readable storage medium encodes computer executable instructions that, when executed by at least one processor, performs a method for real-time prediction of one or more aspects associated with a fashion retailer for productive sales. The method includes a first step to receive a plurality of data associated with a plurality of stores of each of one or more fashion retailers at a computing device. In addition, the method includes a second step to bin a liquidation sales data from the plurality of data at the computing device. The binning is done to eliminate the liquidation sales data from the plurality of data based on a revenue loss threshold on a plurality of products. Further, the method includes a third step to cluster the plurality of products into one or more clusters at one or more levels at the computing device. The clustering is done based on one or more attributes of the plurality of products and the plurality of stores of each of the one or more fashion retailers. The clustering is done in real-time. Furthermore, the method includes a fourth step to smooth the plurality of data for each of the one or more clusters at each of the one or more levels based on moving averages analysis. The smoothing is done to enable prediction of the one or more aspects at the one or more levels. The smoothing of the plurality of data is done in real-time. Moreover, the method includes a fifth step to predict the one or more aspects associated with each of the plurality of products and the plurality of stores of each of the one or more fashion retailers. The prediction is done to achieve a user defined revenue target in a pre-defined period of time for a plurality of results. The plurality of results includes determination of a popularity index, optimization of quantity, and maximizing revenue. The one or more aspects are predicted in real-time.

### BRIEF DESCRIPTION OF THE DRAWINGS

Having thus described the invention in general terms, reference will now be made to the accompanying drawings, which are not necessarily drawn to scale, and wherein:

FIG. 1 illustrates a block diagram of one or more fashion retailers, in accordance with various embodiments of the present disclosure;

FIG. 2 illustrates an interactive computing environment for real-time prediction of one or more aspects associated with a fashion retailer for productive sales, in accordance with various embodiments of the present disclosure;

FIGS. 3A and 3B illustrate a flow chart of the method for real-time prediction of the one or more aspects associated with the fashion retailer for productive sales, in accordance with various embodiments of the present disclosure; and

FIG. 4 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

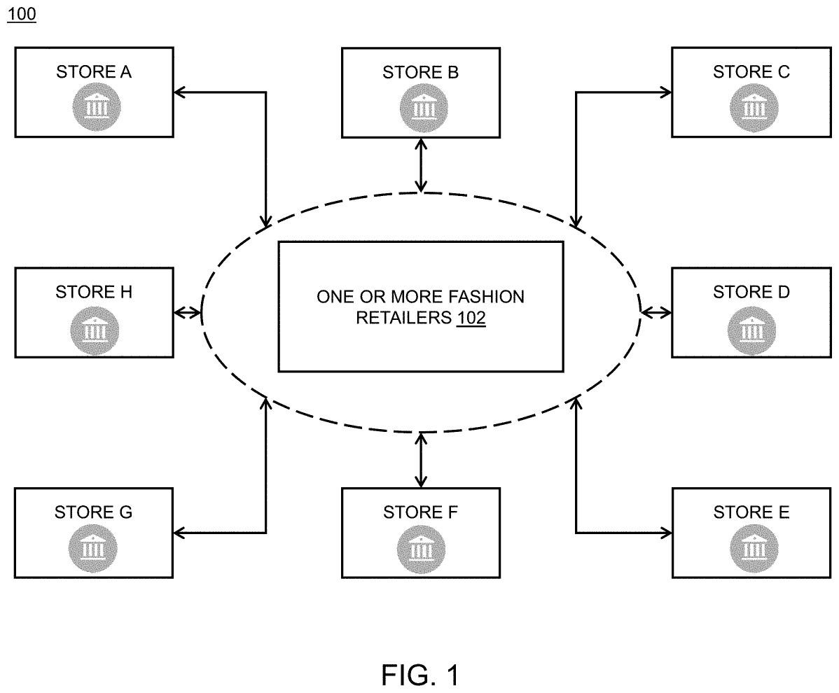

FIG. 1 illustrates a block diagram 100 of one or more fashion retailers 102, in accordance with various embodiments of the present disclosure. In general, fashion retailers purchase products for resale before consumer is able to buy merchandise in store. The one or more fashion retailers 102 manages flow of merchandise, with a goal of maximizing sales and profitability. The block diagram 100 includes the one or more fashion retailers 102 and a stores A-H. The one or more fashion retailers 102 ensures merchandise planning, merchandise buying and merchandise distribution. In an embodiment of the present disclosure, the one or more fashion retailers 102 seek effective ways to allocate the stocks for the stores A-H. In addition, the one or more fashion retailers 102 seek for a smart assortment plan. Further, the one or more fashion retailers 102 seek effective ways to update the merchandise plan during the season. In general, season includes but may not be limited to Spring, Winter, Resort, and Pre-Fall. Furthermore, the one or more fashion retailers 102 seek effective ways to buy inventory for the stores A-H before the season starts. The stores A-H are associated with the one or more fashion retailers 102. The stores A-H are located at one or more locations. In general, retail store is a place of business owned by fashion retailers in which merchandise is sold primarily to ultimate consumers. In an embodiment of the present disclosure, the stores A-H are multi brand outlets. In another embodiment of the present disclosure, the stores A-H are exclusive brand outlets. In an embodiment of the present disclosure, the stores A-H work on franchise owned franchisee operated model. In another embodiment of the present disclosure, the stores A-H work on franchisee owned company operated model. In yet another embodiment of the present disclosure, the stores A-H work on company owned company operated model.

In an embodiment of the present disclosure, each of the stores A-H is similar in structure and facilities. In another embodiment of the present disclosure, each of the stores A-H is not similar in structure and facilities. In addition, the stores A-H include a plurality of products. The plurality of products includes Jackets, Coats, Trousers, Shorts, Suits, Skirts, Dresses, Sweaters, Waistcoats, Traditional wear, Jeans, Formal wear, Undergarments, Accessories, and the like. In an embodiment of the present disclosure, each of the stores A-H has capacity of 5000 products. In another embodiment of the present disclosure, each of the store A-H has capacity of 8000 products. In yet another embodiment of the present disclosure, each of the store A-H has capacity of any suitable number of products. In an example, a fashion retailer F1 has 8 number of stores in 8 different cities. In another example, a fashion retailer F2 has 10 number of stores in 10 different states. In yet another example, a fashion retailer F3 has 5 number of stores at same location. In yet another example, a fashion retailer has 10 number of stores in United States.

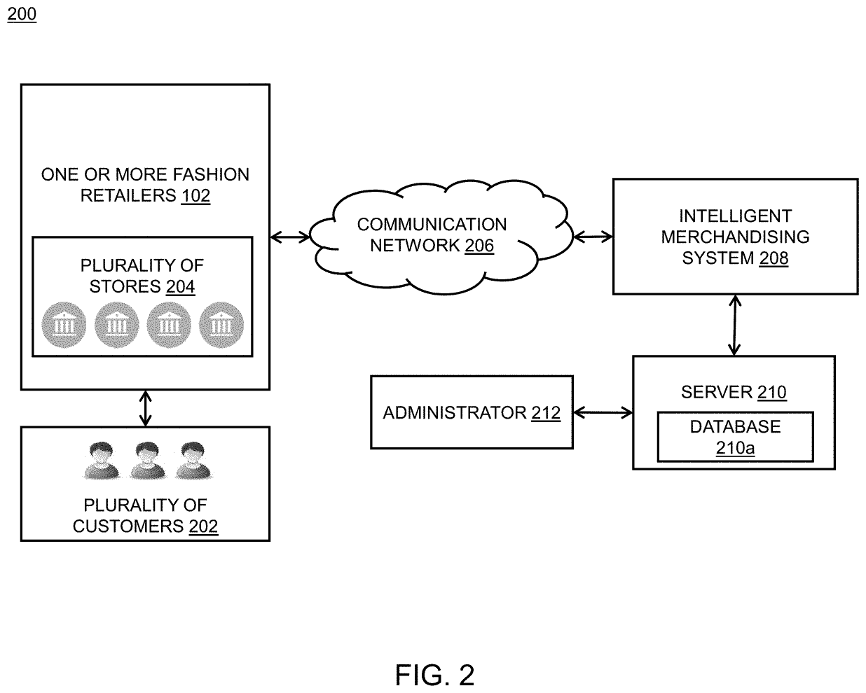

FIG. 2 illustrates an interactive computing environment 200 for real-time prediction of one or more aspects associated with a fashion retailer for productive sales, in accordance with various embodiments of the present disclosure. The interactive computing environment 200 includes a plurality of customers 202, the one or more fashion retailers 102, a plurality of stores 204, and a communication network 206. In addition, the interactive computing environment 200 includes an intelligent merchandising system 208, a server 210, a database 210a, and an administrator 212. Further, the intelligent merchandising system 208 predicts a set of merchandise categories of the plurality of products for a pre-defined period of time. Furthermore, the intelligent merchandising system 208 predicts a first set of products from the plurality of products. Moreover, the intelligent merchandising system 208 predicts a set of quantities of the plurality of products for the pre-defined period of time. Also, the intelligent merchandising system 208 predicts a set of size set ratio of the plurality of products. Also, the intelligent merchandising system 208 predicts a second set of products from the plurality of products.

The interactive computing environment 200 includes the plurality of customers 202. The plurality of customers 202 corresponds to any number of person or individual buying the plurality of products from the plurality of stores 204 associated with the one or more fashion retailers 102. The plurality of customers 202 demands the plurality of products at the plurality of stores 204. The interactive computing environment 200 provides an interface for the plurality of customers 202 to interact with the one or more fashion retailers 102.

In an example, a customer C1 buys a slim fit jeans of a brand B1 from a store S1 of a fashion retailer F1. In another example, a customer C2 buys a formal shirt (let's say a white color) of extra-large size from a store S2 of a fashion retailer F2. In yet another example, a customer C3 buys a traditional wear dress from a store S3 of a fashion retailer F3. In yet another example, a customer C4 buys a frock for an 8 year old girl child from a store S4 of a fashion retailer F4. In yet another example, a customer C5 buys party wear dress of black color from a store S5 of a fashion retailer F5. In yet another example, a customer C6 buys casual blazer of navy blue color from a store S6 of a fashion retailer F6. In yet another example, a customer C7 buys an informal trouser of beige color from a store S7 of a fashion retailer F7.

The interactive computing environment 200 includes the one or more fashion retailers 102. The one or more fashion retailers 102 correspond to any number of fashion organization associated with the intelligent merchandising system 208 which provides channel for the plurality of customers 202 in form of the plurality of stores 204. In addition, each of the one or more fashion retailers 102 has the plurality of stores 204 at the one or more locations for visual merchandising of the plurality of products to the plurality of customers 202. Further, each of the one or more fashion retailers 102 manages the inventory and stock allocation for the plurality of stores 204 based on past sales data and seasonality data of the plurality of products. Furthermore, one or more fashion retailers 102 perform transmission of a plurality of data with facilitation of the communication network 106. In an example, a fashion retailer F1 manages a sales data S1 of 8 stores located in eight major cities across the country. In another example, a fashion retailer F2 manages a sales data S2 of 10 stores located within the city C2. In yet another example, a fashion retailer F3 manages sales data S3 of 100 stores located in 70 major cities across the globe. In yet another example, a fashion retailer F4 allocates stock for the 10 stores located in one province (let's say Texas).

The interactive computing environment 200 includes the plurality of stores 204. The plurality of stores 204 corresponds to any number of retail store associated with the one or more fashion retailers 102 which provides visual merchandising platform for the plurality of customers 202. In an embodiment of the present disclosure, the plurality of stores 204 is a chain stores. In general, chain store is a retail outlet present at different locations share a brand, central management, and standardized business practices. In another embodiment of the present disclosure, the plurality of stores 204 is a departmental stores. In general, department store is a retail store establishment offering a wide range of consumer products in different categories. In yet another embodiment of the present disclosure, the plurality of stores 204 is a supermarket. In general, supermarket is self-service shop offering a wide variety of fashion products, organized into sections and shelves. In an example, a store S1 has a capacity to store 5000 quantity of products. In another example, a store S2 has a capacity to store 8000 quantity of products. In yet another example, a store S3 has a capacity to store 10,000 quantity of products.

The interactive computing environment 200 includes the communication network 206. The one or more fashion retailers 102, and the intelligent merchandising system 208 are connected to the communication network 206. The communication network 206 provides a medium to transfer the plurality of data associated with the one or more fashion retailers 102 to the intelligent merchandising system 208. The communication network 206 provides the medium for the one or more fashion retailers 102 to connect with the intelligent merchandising system 208. In an embodiment of the present disclosure, the communication network 206 is an internet connection. In another embodiment of the present disclosure, the communication network 206 is a wireless mobile network. In yet another embodiment of the present disclosure, the communication network 206 is a wired network with a finite bandwidth. In yet another embodiment of the present disclosure, the communication network 206 is a combination of the wireless and the wired network for the optimum throughput of data transmission. In yet another embodiment of the present disclosure, the communication network 206 is an optical fiber high bandwidth network that enables a high data rate with negligible connection drops. The communication network 206 includes a set of channels. Each channel of the set of channels supports a finite bandwidth. Moreover, the finite bandwidth of each channel of the set of channels is based on capacity of the communication network 206. The communication network 206 connects the one or more fashion retailers 102 to the intelligent merchandising system 208 using a plurality of methods. The plurality of methods used to provide network connectivity includes 2G, 3G, 4G, 5G, Wifi and the like.

The interactive computing environment 200 includes the intelligent merchandising system 208. The intelligent merchandising system 208 enables prediction of the set of merchandise categories of the plurality of products for the pre-defined period of time. In addition, the intelligent merchandising system 208 enables prediction of the first set of products from the plurality of products. Further, the intelligent merchandising system 208 enables prediction of the set of quantities of the plurality of products for the pre-defined period of time. Furthermore, the intelligent merchandising system 208 enables prediction of the set of size set ratio for the plurality of products. Moreover, the intelligent merchandising system 208 enables identification of optimal assortment plan for the one or more fashion retailers 102. Also, intelligent merchandising system 208 enables prediction of optimal stock allocation plan for the plurality of stores 204 of each of the one or more fashion retailers 102.

The intelligent merchandising system 208 receives the plurality of data associated with the plurality of stores 204 of each of the one or more fashion retailers 102. In addition, the plurality of data is in one or more formats. The one or more formats include comma-separated values (CSV) format, Microsoft Excel Open XML format, plain text format, JavaScript Object Notation format, Image file format, Hierarchical Data Format, Portable Document Format, and the like. In general, format is a standard way in which information is encoded for storage in a file. In an embodiment of the present disclosure, the plurality of data includes past sales data and seasonality data. In another embodiment of the present disclosure, the plurality of data includes product attributes data, store inventory data and warehouse inventory data. The plurality of data is received from each of the plurality of stores 204 of each of the one or more fashion retailers 102 in the one or more formats. In an example, a fashion retailer F1 sends past sales data to intelligent merchandising system in comma-separated values format. In another example, a fashion retailer F2 sends seasonality data to intelligent merchandising system in Microsoft Excel Open XML format. In yet another example, a fashion retailer F4 sends store inventory data to intelligent merchandising system in JavaScript Object Notation format.

The intelligent merchandising system 208 bins a liquidation sales data from the plurality of data. In addition, the liquidation sales data corresponds to sales data of a third set of products from the plurality of products. Further, the third set of products contributed above a revenue loss threshold. Furthermore, the liquidation sales data contributes up to a pre-defined revenue. In an embodiment of the present disclosure, the threshold discount is maximum allowable discount on the plurality of products to avoid liquidation sales. The revenue loss threshold and the pre-defined revenue is defined by the one or more fashion retailers 102. In an embodiment of the present disclosure, the pre-defined revenue is trivial amount of total revenue of the one or more fashion retailers 102. The binning is done to eliminate the liquidation sales data from the plurality of data based on the revenue loss threshold on the plurality of products. In an embodiment of the present disclosure, the third set of products is a set of products that contributes up to the pre-defined revenue. In an example, a fashion retailer F1 defines sales contributing up to 10% of revenue as the liquidation sales that has to be removed. In another example, a fashion retailer F2 defines sales contributing up to 8% of revenue as the liquidation sales that has to be removed. In yet another example, a fashion retailer F3 defines sales contributing up to 12% of revenue as the liquidation sales that has to be removed. In an embodiment of the present disclosure, the revenue loss threshold on the plurality of products is based on a similarity factor. The similarity factor is defined by the one or more fashion retailers 102. The binning is done for high discounts sales data within the range of the similarity factor of each other. In an example, a fashion retailer F1 defines the value of the similarity factor as 0.9. In another example, a fashion retailer F2 defines the value of the similarity factor as 0.95. In yet another example, a fashion retailer F3 defines the value of the similarity factor as 0.85.

The intelligent merchandising system 208 clusters the plurality of products into one or more clusters at one or more levels using one or more hardware-run algorithms. In an embodiment of the present disclosure, the one or more hardware-run algorithms include machine learning algorithms and deep learning algorithms. In addition, the one or more hardware-run algorithms include prediction algorithms, phonetic distance based fuzzy search algorithms and the like. In an embodiment of the present disclosure, the one or more hardware-run algorithms include a K-means clustering algorithm. In another embodiment of the present disclosure, the one or more hardware-run algorithms include a decision tree algorithm and a random forest algorithm. In yet another embodiment of the present disclosure, the one or more hardware-run algorithms include but may not be limited to prediction algorithms, deep learning algorithms, natural language processing algorithm and the like. However, the one or more hardware-run algorithms are not limited to the above-mentioned algorithms. The one or more levels include style, organization, cluster, size, store, and the like. In general, clustering is very important to determine the intrinsic grouping among the unlabeled data present. In addition, the clustering is done based on one or more attributes of the plurality of products and the plurality of stores 204 of each of the one or more fashion retailers 102. The one or more attributes include merchandise category, price-range, size ratio, fabric, color, design, brand, fit, and the like. The clustering is done in real-time.

In an embodiment of the present disclosure, the intelligent merchandising system 208 clusters the plurality of products at a store level based on merchandise category. In general, merchandise category is a grouping of products by characteristics of products. In addition, the merchandise category includes Men's clothing, Men's footwear, Men's grooming, Men's seasonal wear, Ladies apparel, Kid's clothing, Women's ethnic clothing, and the like. In another embodiment of the present disclosure, the intelligent merchandising system 208 clusters the plurality of products at an organization level based on merchandise category. In addition the organization level corresponds to level of each of the one or more fashion retailers 102. In yet another embodiment of the present disclosure, the intelligent merchandising system 208 clusters the plurality of products at a size level based on merchandise category. In general, size includes extra small, small, medium, large, extra-large, 2T, 4T, and the like.

In an embodiment of the present disclosure, the intelligent merchandising system 208 clusters the plurality of products at the store level based on fabric. In general, fabric corresponds to material consisting of fiber networks. In addition, fabric includes wool, cotton, silk, linen, nylon, satin, viscose rayon, and the like. In another embodiment of the present disclosure, the intelligent merchandising system 208 clusters the plurality of products at the organization level based on fabric. In yet another embodiment of the present disclosure, the intelligent merchandising system 208 clusters the plurality of products at the size level based on fabric.

In an embodiment of the present disclosure, the intelligent merchandising system 208 clusters the plurality of products at the store level based on price-range. In general, price-range corresponds to range of prices at which products are sold. In addition, price-range includes premium price-range, penetration price-range, economical price-range, and the like. In another embodiment of the present disclosure, the intelligent merchandising system 208 clusters the plurality of products at the organization level based on price-range. In yet another embodiment of the present disclosure, the intelligent merchandising system 208 clusters the plurality of products at the size level based on price-range.

In an embodiment of the present disclosure, the intelligent merchandising system 208 clusters the plurality of products at the store level based on size ratio. In general, size ratio corresponds to a pack of mixed sizes of products. In another embodiment of the present disclosure, the intelligent merchandising system 208 clusters the plurality of products at the organization level based on size ratio. In yet another embodiment of the present disclosure, the intelligent merchandising system 208 clusters the plurality of products at the size level based on size ratio.

In an embodiment of the present disclosure, the intelligent merchandising system 208 clusters the plurality of products at the store level based on color. In general, color includes black, brown, blue, green, purple, red, yellow, white, orange, pink, and the like. In another embodiment of the present disclosure, the intelligent merchandising system 208 clusters the plurality of products at the organization level based on color. In yet another embodiment of the present disclosure, the intelligent merchandising system 208 clusters the plurality of products at the size level based on color.

In an embodiment of the present disclosure, the intelligent merchandising system 208 clusters the plurality of products at the store level based on fit. In general, fit includes regular fit, traditional fit, slim fit, athletic fit, and the like. In another embodiment of the present disclosure, the intelligent merchandising system 208 clusters the plurality of products at the organization level based on fit. In yet another embodiment of the present disclosure, the intelligent merchandising system 208 clusters the plurality of products at the size level based on fit.

The intelligent merchandising system 208 evaluates a popularity index of each of the plurality of products based on analysis of the plurality of data at the one or more levels for the pre-defined period of time. The pre-defined period of time includes year, quarter, month, and the like. The popularity index is based on a plurality of parameters of each of the plurality of products. In addition, the plurality of parameters includes revenue and discount. Further, the popularity index allows the intelligent merchandising system 208 to predict the first set of products from the plurality of products. Furthermore, the popularity index is evaluated in real-time. The expression used for calculating the popularity index is given below:

Popularity Index=Revenue×(1−Discount)

In an example, Style S1 has a revenue of 2 and a discount of 10%. In addition, the popularity index P1 has a value of 1.8 using the above expression. In another example, Style S2 has a revenue of 3 and a discount of 30%. In addition, the popularity index P2 has a value of 2.1 using the above expression. In yet another example, Style S3 has a revenue of 4 and a discount of 20%. In addition, the popularity index P3 has a value of 3.2 using the above expression. In yet another example, Style S4 has a revenue of 3 and a discount of 40%. In addition, the popularity index P4 has a value of 1.8 using the above expression. In yet another example, Style S5 has a revenue of 1 and a discount of 5%. In addition, the popularity index P5 has a value of 0.95 using the above expression. In yet another example, Style S6 has a revenue of 5 and a discount of 10%. In addition, the popularity index P6 has a value of 4.5 using the above expression. In yet another example, Style S7 has a revenue of 2 and a discount of 50%. In addition, the popularity index P7 has a value of 1 using the above expression. The intelligent merchandising system 208 bins products from the plurality of products based on the popularity index above a threshold value for the pre-defined period of time. In addition, the threshold value is defined by the one or more fashion retailers 102. Further, the products correspond to the first set of products of the plurality of products. The binning of the first set of products from the plurality of products is done in real-time. In an embodiment of the present disclosure, the first set of products corresponds to a set of most popular products of the plurality of products. In addition, the first set of products has discount below the threshold discount. Further, the first set of products contributes most to achieve a user defined revenue target. Furthermore, the one or more fashion retailers 102 defines the user defined revenue target for the pre-defined period of time. In an embodiment of the present disclosure, the user defined revenue target is revenue the one or more fashion retailers 102 are targeting for the pre-defined period of time.

The intelligent merchandising system 208 smooths the plurality of data for each of the one or more clusters at each of the one or more levels based on moving averages analysis. In general, moving average is a mathematical practice used in technical analysis that smooths history data by averaging daily data over some period of time. The smoothing is done to control a set of distributions and a set of sales of the plurality of products at the one or more levels. In addition, the set of distributions includes out of stock, over stock, poor procurement, and the like. Further, the set of sales is based on the one or more attributes of the plurality of products. The smoothing ensures that variations in the plurality of data are aligned using the moving averages analysis. The smoothing is done to enable prediction of the one or more aspects at the one or more levels. The smoothing of the plurality of data is done in real-time. In an example, store S1 has a popularity 10000 for style 1 for first month. In addition, store S1 has a popularity 2000 for style 1 for second month. Further, store S1 has a popularity 0 for style 1 for third month. Furthermore, store S1 has a popularity 15000 for style 1 for fourth month. Moreover, the smoothened popularity is 8000, 4000, 2500, and 12500 for the first month, the second month, the third month, and the fourth month respectively. In another example, store S2 has a quantity 100 for style 2 for first month. In addition, store S2 has a quantity 50 for style 2 for second month. Further, the smoothened quantity is 87.5, and 62.5 for the first month, and the second month respectively.

In an example, organization O1 has a popularity 1000 for cluster 1 for first month. In addition, organization O1 has a popularity 200 for cluster 1 for second month. Further, the smoothened popularity is 800, and 400 for the first month, and the second month respectively. In another example, organization O2 has a quantity 1000 for cluster 2 for first month. In addition, organization O2 has a quantity 600 for cluster 2 for second month. Further, the smoothened quantity is 900, and 700 for the first month, and the second month respectively.

In an example, a store S3 has a sales of 3 thousand US dollars for cluster 4 for first month. In addition, the store S3 has the sales of 4 thousand US dollars for cluster 4 for second month. Further, the store S3 has the sales of 8 thousand US dollars for cluster 4 for third month. Furthermore, the store S3 has the sales of 6 thousand US dollars for cluster 4 for fourth month. Moreover, the store S3 has the sales of 7 thousand US dollars for cluster 4 for fifth month. Also, 3-monthly smoothened sales for the cluster 4 are 5 thousand US dollars, 6 thousand US dollars, 7 thousand US dollars, and 8 thousand US dollars for the second month, the third month, the fourth month and the fifth month respectively.

The intelligent merchandising system 208 predicts the one or more aspects associated with each of the plurality of products and the plurality of stores 204 of each of the one or more fashion retailers 102. In an embodiment of the present disclosure, the one or more aspects include the set of merchandise categories of the plurality of products for the pre-defined period of time, and the first set of products from the plurality of products. In another embodiment of the present disclosure, the one or more aspects include a set of quantities of the plurality of products for the pre-defined period of time, and a set of options of the plurality of products. In yet another embodiment of the present disclosure, the one or more aspects include the set of size set ratio of the plurality of products and optimal allocation of the plurality of products. In yet another embodiment of the present disclosure, the one or more aspects include the second set of products from the plurality of products, and the set of selling price of the plurality of products. The prediction is done to achieve the user defined revenue target in the pre-defined period of time for a plurality of results. The plurality of results includes determination of the popularity index, optimization of quantity, maximizing revenue, and the like. The one or more aspects are predicted in real-time.

In an embodiment of the present disclosure, the intelligent merchandising system 208 predicts the set of merchandise categories of the plurality of products for the pre-defined period of time. In addition, the set of merchandise categories corresponds to optimal mix of merchandise category. In an example, set of merchandise categories S1 includes 25% of Men's clothing, 10% A Men's footwear, 35% of Men's grooming, and 30% of Men's seasonal wear. In another example, set of merchandise categories S2 includes 40% of Ladies apparel, 20% of Kid's clothing, and 40% of Women's ethnic clothing. In an embodiment of the present disclosure, the intelligent merchandising system 208 predicts the set of merchandise categories of the plurality of products for each of the plurality of stores 204. In another embodiment of the present disclosure, the intelligent merchandising system 208 predicts the set of merchandise categories of the plurality of products for each of the one or more fashion retailers 102.

In an embodiment of the present disclosure, the intelligent merchandising system 208 predicts the first set of products from the plurality of products for the pre-defined period of time. In addition, the first set of products corresponds to the set of most popular products of the plurality of products. In an example, set of popular products S1 includes spread collar black color shirt, formal red color shirt, and club collar yellow color casual shirt. In another example, set of popular products S2 includes women's cotton hoodie, cherry color slim-fit leather jacket, and navy blue colored women's cotton sweatshirt. In an embodiment of the present disclosure, the intelligent merchandising system 208 predicts the first set of products from the plurality of products for each of the plurality of stores 204. In another embodiment of the present disclosure, the intelligent merchandising system 208 predicts the first set of products from the plurality of products for each of the one or more fashion retailers 102.

In an embodiment of the present disclosure, the intelligent merchandising system 208 predicts the set of quantities of the plurality of products for the pre-defined period of time. In addition, the set of quantities corresponds to optimal quantities of the plurality of products required to maximize revenue. In an example, set of quantities S1 includes 1,000 quantity of formal white shirt, 500 quantity of extra-large black shirt, and 200 quantity of informal yellow shirt. In an embodiment of the present disclosure, the intelligent merchandising system 208 predicts the set of quantities of the plurality of products for each of the plurality of stores 204. In another embodiment of the present disclosure, the intelligent merchandising system 208 predicts the set of quantities of the plurality of products for each of the one or more fashion retailers 102.

In an embodiment of the present disclosure, the intelligent merchandising system 208 predicts the set of options of the plurality of products for the pre-defined period of time. In addition, the set of options corresponds to optimal options of the plurality of products. In general, Options define variations within a single product for a single attribute. In an example, set of options S1 includes 20 options of formal yellow shirt, 10 options of informal red shirt, and 25 option of collars. In another example, set of options S2 includes 10 options of black ethnic wear, 20 options of Kid's Party Wear, and 25 options of formal lace-less shoes. In an embodiment of the present disclosure, the intelligent merchandising system 208 predicts the set of options of the plurality of products for each of the plurality of stores 204. In another embodiment of the present disclosure, the intelligent merchandising system 208 predicts the set of options of the plurality of products for each of the one or more fashion retailers 102.

In an embodiment of the present disclosure, the intelligent merchandising system 208 predicts the set of size set ratio of the plurality of products for the pre-defined period of time. In addition, the set of size set ratio corresponds to true size set ration for each of the plurality of products. In general, size ratio is ratio of mixed sizes of products. In addition, size ratio gives equal mix of each size according to requirement of retail store. In an example, set of size set ratio S1 for a product P1 is 0.7:1.8:2.0:2.3:1.5 for extra-small size, small size, medium size, large size, and extra-large size respectively. In another example, set of size set ratio S2 for a product P2 is 1.2:2.5:2.1:1.7:0.5 for extra-small size, small size, medium size, large size, and extra-large size respectively. In an embodiment of the present disclosure, the intelligent merchandising system 208 predicts the set of size set ratio of the plurality of products for each of the plurality of stores 204. In another embodiment of the present disclosure, the intelligent merchandising system 208 predicts the set of size set ratio of the plurality of products for each of the one or more fashion retailers 102.

The interactive computing environment 200 further includes the server 210 and the database 210a. The intelligent merchandising system 208 is associated with the server 210. In general, the server is a computer program or device that provides functionality for other programs or devices. The server 210 provides various functionalities, such as sharing data or resources among multiple clients, or performing computation for a client. However, those skilled in the art would appreciate that the intelligent merchandising system 208 is connected to more number of servers. Furthermore, it may be noted that the server 210 includes the database 210a. However, those skilled in the art would appreciate that more number of the servers include more numbers of database.

In an embodiment of the present disclosure, the intelligent merchandising system 208 is located in the server 210. In another embodiment of the present disclosure, the intelligent merchandising system 208 is connected with the server 210. In yet another embodiment of the present disclosure, the intelligent merchandising system 208 is a part of the server 210. The server 210 handles each operation and task performed by the intelligent merchandising system 208. The server 210 stores one or more instructions for performing the various operations of the intelligent merchandising system 208. The server 210 is located remotely from the one or more fashion retailers 102. The server 210 is associated with the administrator 212. In general, the administrator manages the different components in the intelligent merchandising system 208. The administrator 212 coordinates the activities of the components involved in the intelligent merchandising system 208. The administrator 212 is any person or individual who monitors the working of the intelligent merchandising system 208 and the server 210 in real time. The administrator 212 monitors the working of the intelligent merchandising system 208 and the server 210 through a communication device. The communication device includes the laptop, the desktop computer, the tablet, a personal digital assistant and the like.

The database 210a store different sets of information associated with various components of the intelligent merchandising system 208. In general, the databases are used to hold general information and specialized data, such as characteristics data of customers, data of the stores, data of the fashion retailers and the like. The database 210a stores the information of the one or more fashion retailers 102, the plurality of stores 204, the profiles of the plurality of customers 202, demographic information of the plurality of customers 202 and the like. The database 210a organizes the data using model such as relational models or hierarchical models. Further, the database 210a store data provided by the one or more fashion retailers 102.

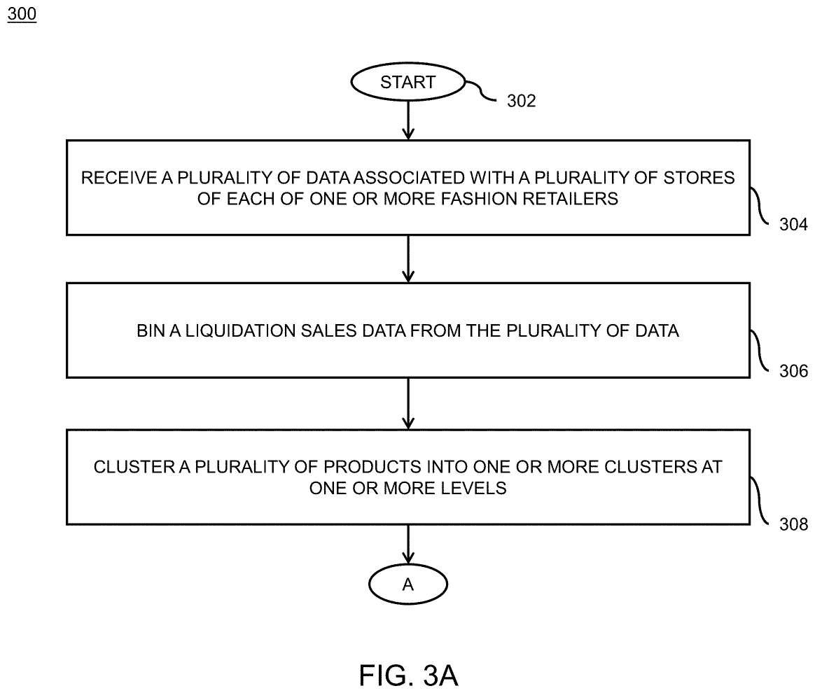

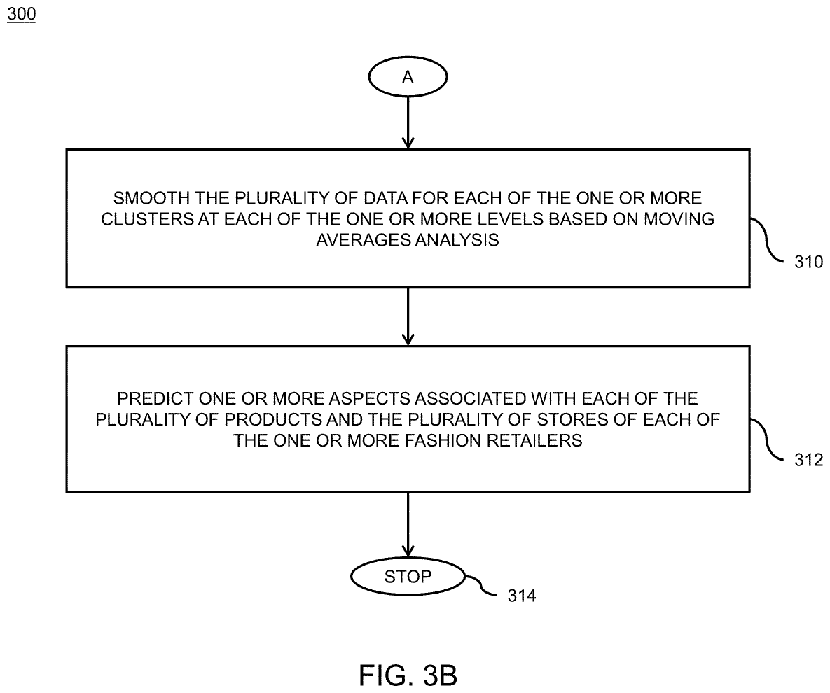

FIGS. 3A and 3B illustrate a flow chart 300 of the method for real-time prediction of the one or more aspects associated with a fashion retailer for productive sales, in accordance with various embodiments of the present disclosure. It may be noted that in order to explain the method steps of the flowchart 300, references will be made to the elements explained in FIG. 2. The flow chart 300 starts at step 302. At step 304, the intelligent merchandising system 208 receives the plurality of data associated with the plurality of stores 204 of each of the one or more fashion retailers 102. At step 306, the intelligent merchandising system 208 bins the liquidation data from the plurality of data. At step 308, the intelligent merchandising system 208 clusters the plurality of products into the one or more clusters at the one or more levels. At step 310, the intelligent merchandising system 208 smooths the plurality of data for each of the one or more clusters at each of the one or more levels based on moving averages analysis. At step 312, the intelligent merchandising system 208 predicts the one or more aspects associated with each of the plurality of products and the plurality of stores 204 of each of the one or more fashion retailers 102.

The flow chart 300 terminates at step 314. It may be noted that the flowchart 300 is explained to have above stated process steps; however, those skilled in the art would appreciate that the flowchart 300 may have more/less number of process steps which may enable all the above stated embodiments of the present disclosure.

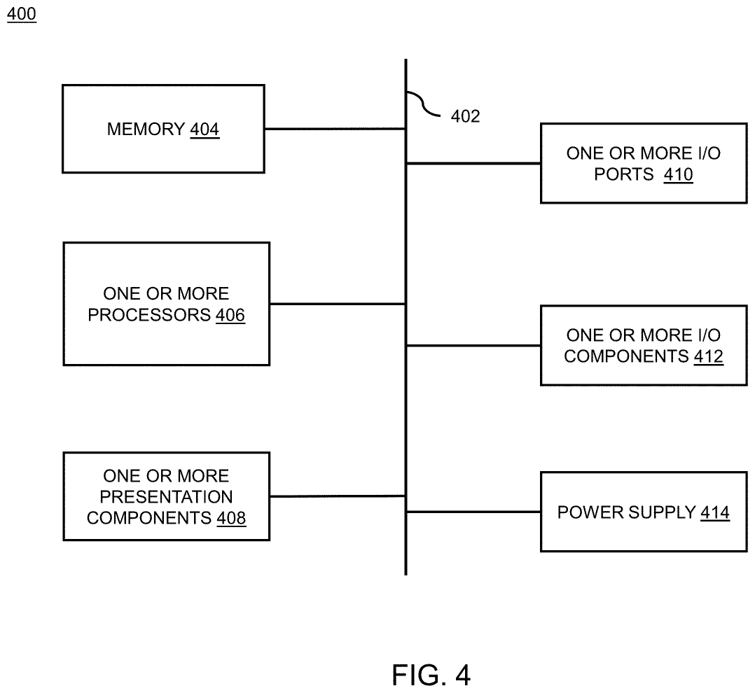

FIG. 4 illustrates a block diagram of a computing device 400, in accordance with various embodiments of the present disclosure. The computing device 400 includes a bus 402 that directly or indirectly couples the following devices: memory 404, one or more processors 406, one or more presentation components 408, one or more input/output (I/O) ports 410, one or more input/output components 412, and an illustrative power supply 414. The bus 402 represents what may be one or more busses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 4 is merely illustrative of an exemplary computing device 400 that can be used in connection with one or more embodiments of the present invention. Distinction is not made between such categories as “workstation,” “server,” “laptop,” “hand-held device,” etc., as all are contemplated within the scope of FIG. 4 and reference to “computing device”.

The computing device 400 typically includes a variety of computer-readable media. The computer-readable media can be any available media that can be accessed by the computing device 400 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data.

The computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 400. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 404 includes computer-storage media in the form of volatile and/or nonvolatile memory. The memory 404 may be removable, non-removable, or a combination thereof. Exemplary hardware devices include solid-state memory, hard drives, optical-disc drives, etc. The computing device 400 includes one or more processors that read data from various entities such as memory 404 or I/O components 412. The one or more presentation components 408 present data indications to a subscriber or other device. Exemplary presentation components include a display device, speaker, printing component, vibrating component, etc. The one or more I/O ports 410 allow the computing device 400 to be logically coupled to other devices including the one or more I/O components 412, some of which may be built in. Illustrative components include a microphone, joystick, game pad, satellite dish, scanner, printer, wireless device, etc.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed:

1. A computer-implemented method for creating real-time prediction of one or more aspects associated with a fashion retailer for productive sales, the computer-implemented method comprising:
receiving, at an intelligent merchandising system with a processor, a plurality of data associated with a plurality of stores of each of one or more fashion retailers;
binning, at the intelligent merchandising system with the processor, a liquidation sales data from the plurality of data, wherein the binning is done for eliminating the liquidation sales data from the plurality of data based on a revenue loss threshold on a plurality of products;
clustering, at the intelligent merchandising system with the processor, the plurality of products into one or more clusters at one or more levels, wherein the clustering is done based on one or more attributes of the plurality of products and the plurality of stores of each of the one or more fashion retailers, wherein the clustering is done in real-time;
smoothing, at the intelligent merchandising system with the processor, the plurality of data for each of the one or more clusters at each of the one or more levels based on moving averages analysis, wherein the smoothing is done for enabling prediction of the one or more aspects at the one or more levels, wherein the smoothing of the plurality of data is done in real-time; and
predicting, at the intelligent merchandising system with the processor, the one or more aspects associated with each of the plurality of products and the plurality of stores of each of the one or more fashion retailers, wherein the prediction is done for achieving a user defined revenue target in a pre-defined period of time for a plurality of results, wherein the user defined revenue target is defined by the one or more fashion retailers, wherein the plurality of results comprising determination of a popularity index, optimization of quantity, and maximizing revenue, wherein the one or more aspects are predicted in real-time.

2. The computer implemented method as claimed in claim 1, wherein the plurality of data comprising past sales data, seasonality data, product attributes data, store inventory data, and warehouse inventory data.

3. The computer-implemented method as claimed in claim 1, wherein the one or more levels comprising style, organization, cluster, size, and store.

4. The computer-implemented method as claimed in claim 1, wherein the one or more attributes comprising merchandise category, price-range, size ratio, fabric, color, design, brand and fit.

5. The computer-implemented method as claimed in claim 1, wherein the one or more aspects comprising a set of merchandise categories of the plurality of products for the pre-defined period of time, a first set of products from the plurality of products, a set of quantities of the plurality of products for the pre-defined period of time, a set of options of the plurality of products, a set of size set ratio of the plurality of products, optimal allocation of the plurality of products, a second set of products from the plurality of products, and a set of selling price of the plurality of products.

6. The computer-implemented method as claimed in claim 1, wherein the liquidation sales data corresponds to sales data of a third set of products from the plurality of products, wherein the liquidation sales data contributes up to pre-defined revenue, wherein the pre-defined revenue is defined by the one or more fashion retailers.

7. The computer-implemented method as claimed in claim 1, wherein the smoothing is done for controlling a set of distributions and a set of sales of the plurality of products at the one or more levels, wherein the set of distributions comprising out of stock, over stock, and poor procurement, wherein the set of sales is based on the one or more attributes of the plurality of products, wherein the smoothing ensures that variation in the plurality of data are aligned using the moving averages analysis.

8. The computer-implemented method as claimed in claim 1, further comprising evaluating, at the intelligent merchandising system, the popularity index of each of the plurality of products based on analysis of the plurality of data at the one or more levels for the pre-defined period of time, wherein the popularity index is based on a plurality of parameters of each of the plurality of products, wherein the plurality of parameters comprising revenue and discount, wherein the popularity index enables prediction of the first set of products from the plurality of products, wherein the popularity index is evaluated in real-time.

9. The computer-implemented method as claimed in claim 1, further comprising binning, at the intelligent merchandising system, products from the plurality of products based on the popularity index above a threshold value for the pre-defined period of time, wherein the threshold value is defined by the one or more fashion retailers, wherein the products correspond to the first set of products from the plurality of products, wherein the binning is done in real-time.

10. A computer system comprising:
one or more processors; and
a memory coupled to the one or more processors, the memory for storing instructions which, when executed by the one or more processors, cause the one or more processors to perform a method for real-time prediction of one or more aspects associated with a fashion retailer for productive sales, the method comprising:
receiving, at an intelligent merchandising system, a plurality of data associated with a plurality of stores of each of one or more fashion retailers;
binning, at the intelligent merchandising system, a liquidation sales data from the plurality of data, wherein the binning is done for eliminating the liquidation sales data from the plurality of data based on a revenue loss threshold on a plurality of products;
clustering, at the intelligent merchandising system, the plurality of products into one or more clusters at one or more levels, wherein the clustering is done based on one or more attributes of the plurality of products and the plurality of stores of each of the one or more fashion retailers, wherein the clustering is done in real-time;
smoothing, at the intelligent merchandising system, the plurality of data for each of the one or more clusters at each of the one or more levels based on moving averages analysis, wherein the smoothing is done for enabling prediction of the one or more aspects at the one or more levels, wherein the smoothing of the plurality of data is done in real-time; and
predicting, at the intelligent merchandising system, the one or more aspects associated with each of the plurality of products and the plurality of stores of each of the one or more fashion retailers, wherein the prediction is done for achieving a user defined revenue target in a pre-defined period of time for a plurality of results, wherein the user defined revenue target is defined by the one or more fashion retailers, wherein the plurality of results comprising determination of a popularity index, optimization of quantity, and maximizing revenue, wherein the one or more aspects are predicted in real-time.

11. The computer system as claimed in claim 10, wherein the plurality of data comprising past sales data, seasonality data, product attributes data, store inventory data, and warehouse inventory data.

12. The computer system as claimed in claim 10, wherein the one or more levels comprising style, organization, cluster, size, and store.

13. The computer system as claimed in claim 10, wherein the one or more attributes comprising merchandise category, price-range, size ratio, fabric, color, design, brand and fit.

14. The computer system as claimed in claim 10, wherein the one or more aspects comprising a set of merchandise categories of the plurality of products for the pre-defined period of time, a first set of products from the plurality of products, a set of quantities of the plurality of products for the pre-defined period of time, a set of options of the plurality of products, a set of size set ratio of the plurality of products, optimal allocation of the plurality of products, a second set of products from the plurality of products, and a set of selling price of the plurality of products.

15. The computer system as claimed in claim 10, wherein the liquidation sales data corresponds to sales data of a third set of products from the plurality of products, wherein the liquidation sales data contributes up to a pre-defined revenue, wherein the pre-defined revenue is defined by the one or more fashion retailers.

16. The computer system as claimed in claim 10, wherein the smoothing is done for controlling a set of distributions and a set of sales of the plurality of products at the one or more levels, wherein the set of distributions comprising out of stock, over stock, and poor procurement, wherein the set of sales is based on the one or more attributes of the plurality of products, wherein the smoothing ensures that variation in the plurality of data are aligned using the moving averages analysis.

17. The computer system as claimed in claim 10, further comprising evaluating, at the intelligent merchandising system, the popularity index of each of the plurality of products based on analysis of the plurality of data at the one or more levels for the pre-defined period of time, wherein the popularity index is based on a plurality of parameters of each of the plurality of products, wherein the plurality of parameters comprising revenue and discount, wherein the popularity index enables prediction of the first set of products from the plurality of products, wherein the popularity index is evaluated in real-time.

18. The computer system as claimed in claim 10, further comprising binning, at the intelligent merchandising system (208), products from the plurality of products based on the popularity index above a threshold value for the pre-defined period of time, wherein the threshold value is defined by the one or more fashion retailers (102), wherein the products correspond to the first set of products from the plurality of products, wherein the binning is done in real-time.

19. A non-transitory computer-readable storage medium encoding computer executable instructions that, when executed by at least one processor, performs a method for real-time prediction of one or more aspects associated with a fashion retailer for productive sales, the method comprising:
receiving, at a computing device, a plurality of data associated with a plurality of stores of each of one or more fashion retailers;
binning, at the computing device, a liquidation sales data from the plurality of data, wherein the binning is done for eliminating the liquidation sales data from the plurality of data based on a revenue loss threshold on a plurality of products;
clustering, at the computing device, the plurality of products into one or more clusters at one or more levels, wherein the clustering is done based on one or more attributes of the plurality of products and the plurality of stores of each of the one or more fashion retailers, wherein the clustering is done in real-time;
smoothing, at the computing device, the plurality of data for each of the one or more clusters at each of the one or more levels based on moving averages analysis, wherein the smoothing is done for enabling prediction of the one or more aspects at the one or more levels, wherein the smoothing of the plurality of data is done in real-time; and
predicting, at the computing device, the one or more aspects associated with each of the plurality of products and the plurality of stores of each of the one or more fashion retailers, wherein the prediction is done for achieving a user defined revenue target in a pre-defined period of time for a plurality of results, wherein the user defined revenue target is defined by the one or more fashion retailers, wherein the plurality of results comprising determination of a popularity index, optimization of quantity, and maximizing revenue, wherein the one or more aspects are predicted in real-time.

20. The non-transitory computer-readable storage medium as claimed in claim 19, wherein the plurality of data comprising past sales data, seasonality data, product attributes data, store inventory data, and warehouse inventory data.

21. The non-transitory computer-readable storage medium as claimed in claim 19, wherein further comprising evaluating, at the computing device, the popularity index of each of the plurality of products based on analysis of the plurality of data at the one or more levels for the pre-defined period of time, wherein the popularity index is based on a plurality of parameters of each of the plurality of products, wherein the plurality of parameters comprising revenue and discount, wherein the popularity index enables prediction of the first set of products from the plurality of products, wherein the popularity index is evaluated in real-time.

22. The non-transitory computer-readable storage medium as claimed in claim 19, wherein further comprising binning, at the computing device, products from the plurality of products based on the popularity index above a threshold value for the pre-defined period of time, wherein the threshold value is defined by the one or more fashion retailers, wherein the products correspond to the first set of products from the plurality of products, wherein the binning is done in real-time.
